(19) United States
(12) Patent Application Publication
(10) Pub. No.: US 2018/0129997 A1
(43) Pub. Date: May 10, 2018

(54) SYSTEMS AND METHODS FOR TRACKING AND MANAGING WORK PROJECTS

(71) Applicant: SAN DIEGO COUNTY CREDIT UNION, San Diego, CA (US)

(72) Inventors: CAROLYN FLOYD, SAN DIEGO, CA (US); DAVID JEZEWSKI, SAN DIEGO, CA (US); WIL CUI, SAN DIEGO, CA (US); GRICELDA WATTS, SAN DIEGO, CA (US); STARLI WEST, SAN DIEGO, CA (US); FILIPPO PANDIANI, SAN DIEGO, CA (US)

(73) Assignee: SAN DIEGO COUNTY CREDIT UNION, SAN DIEGO, CA (US)

(21) Appl. No.: 15/348,828

(22) Filed: Nov. 10, 2016

(51) Int. Cl. G06Q 10/06

(52) U.S. Cl. CPC G06Q 10/06313; H04L 67/02; G06Q 10/0633

(57) ABSTRACT

A system and method for tracking and managing projects assigned to one or more group of users on a web based platform is disclosed. In some embodiments, the system includes a processor, a memory attached to the processor, and a computer readable medium having instruction embedded therein. The instructions may be configured to cause the processor to perform the operations of receiving a project request from an authorized user for a project to be created and tracked by the system; generating a workflow template to be applied to the project when a first approval manger approves the project request, where the workflow template provides a starting point or shell for each project type of an approved project request; assigning a project manager to the project; and generating a web based platform to allow authorized users to supervise a workflow of the project in real-time.

### TECHNICAL FIELD

The present technology relates generally to a workflow platform. More particularly, some embodiments of the present invention relate to facilitating the management and execution of the workflow of projects assigned to one or more group of users.

### BACKGROUND

With the advent of the Internet, communicating and sharing files electronically associated with work assignments and projects have become ubiquitous. For example, co-workers often communicate via email or other office messaging tools to transfer work files electronically and/or to provide status updates. However, when there are multiple projects and assignments assigned to one or more employees, managing the various projects and assignments can be difficult to oversee and supervise. And in such instances, projects may often be poorly managed and even lead to important deadlines being missed.

Furthermore, when administrators and managers responsible for supervising and managing the projects are not able to efficiently and effectively track all information needed to manage the workflow of the assigned projects, the work environment becomes easily dysfunctional and inefficient. While there are project management tools currently available to track basic workflow information, such as project names and due dates, most project management tools currently do not provide a streamlined system and method of allowing a group of users to assign, supervise and participate in the workflow of various projects that are responsive to security and user clearance concerns.

Additionally, current project management tools do not provide a comprehensive, cohesive and intuitive system that is easy to use. Rather, most are configured with formal Project Management Office that are tailored to be used by certified Project Management Professional project managers. As a result, such project management tools are complex and do not allow internal supervisors, managers and staff to implement project management tools into wide-spread practice within a company or work place.

### BRIEF SUMMARY OF EMBODIMENTS

According to various embodiments of the disclosed technology, a system for tracking and managing projects is disclosed. In some embodiments, the system includes a processor, a memory attached to the processor; and a computer readable medium having instructions embedded therein. The instructions may be configured to cause the processor to perform the operations of receiving a project request from an authorized user for a project to be created and tracked by the system; generating a workflow template to be applied to the project when a first approval manger approves the project request; assigning a project manager to the project; and generating a web based platform to allow authorized users to complete tasks assigned to the project and supervise a workflow of the project in real-time.

Additionally, a method for tracking and managing work projects on a project tracker platform system is also included. The method may include assigning a role to each user approved to log into the project tracker platform system, such that the role assigned to each user determines a user's clearance and accessibility to information and select web pages; receiving a request from an authorized user to create a project request for approval; generating a project workflow template based on a project type when a first approval manager approves the project request; and assigning a project manager to supervise a workflow of the project in real-time.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a diagram illustrating an example network environment of a project tracker platform system according to one embodiment of the present invention.

FIG. 2 is a flow diagram illustrating an example workflow process of creating and approving a project request in a project tracker platform system according to one embodiment of the present invention.

FIG. 3 is a flow diagram illustrating an example task completion process of an approved project in a project tracker platform system according to one embodiment of the present invention.

FIG. 4 is a flow diagram illustrating an example sign off process of a completed project in a project tracker platform system according to one embodiment of the present invention.

FIG. 5 is an illustration of an example project approval page of a project tracker platform system according to one embodiment of the present invention.

FIG. 6 is an illustration of an example project approval page of a project tracker platform system according to one embodiment of the present invention.

FIG. 7 is an illustration of an example dashboard page of a website portal of a project tracker platform system according to one embodiment of the present invention.

FIG. 8 is an illustration of an example project queue page of a project tracker platform system according to one of the present invention.

FIG. 9 is an illustration of an example project information page of a project tracker platform system according to one embodiment of the present invention.

FIG. 10 is an illustration of a note panel of a project tracker platform system according to one of the present invention.

FIG. 11 is an illustration of a template panel of a project tracker platform system according to one embodiment of the present invention.

FIG. 12 is an illustration of a project score panel of a project tracker platform system according to one embodiment of the present invention.

FIG. 13 is a diagram illustrating an example computing module that may be used to implement features of various embodiments of the disclosure.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The following description is not to be taken in a limiting sense, but is made merely for the purpose of describing the general principles of the disclosed embodiments. The present embodiments address the problems described in the background while also addressing other additional problems as will be seen from the following detailed description. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

Various embodiments of the present invention are directed towards a project tracker platform system. Some embodiments of the disclosure provide a system and method for tracking and managing the workflow of projects on a web based platform. The project tracker platform system allows for the real time execution of assigning and managing all internal projects created within an organization or work place. Additionally, the project tracker platform system allows for users of various management levels to be involved in the complete workflow process of creating, managing, and signing off on the assigned projects.

The project tracker platform system may also include added security levels based on each individual security clearances with the company and with respect to the project. As such, each user may be given an identified role, where the identified role determines the user's clearance to access portions or all of the project materials located within the project tracker platform system. Thus, for example, if a select user is assigned to a manager role, the user may have the authority to approve project requests and create projects, whereas users that are not assigned to an administration or a manger role may have access to only select web pages and information. Additionally, the assigned role of a user may be dependent upon his or her assigned title within the company's hierarchy system. For example, those users that are already considered managers are given a manager role in the project tracker platform system, and those who are supervised by a manager are assigned to non-manager roles.

Certain embodiments of the project tracker platform system may also include the feature of tracking all actions and communications related to the daily project work to satisfy later research, auditors, and examination requirements. Because the project track system provides detailed tracking of all milestones and tasks associated with the project, alerts may also be created to notify administrators and mangers that certain tasks have been completed and are ready to be reviewed.

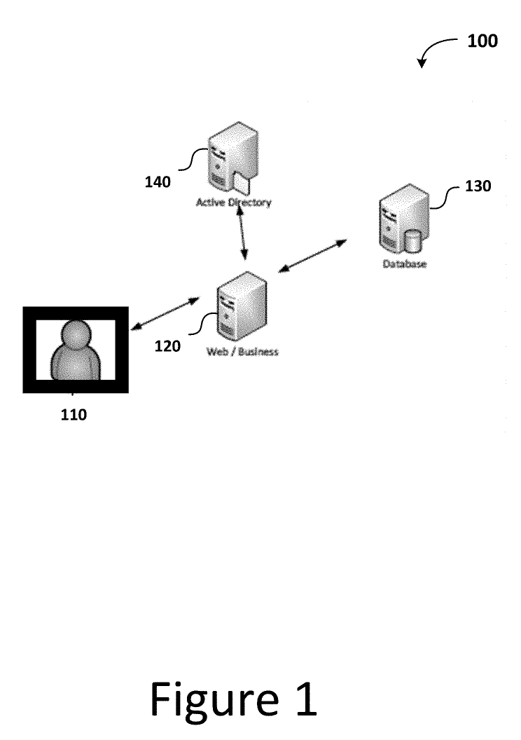

FIG. 1 is a diagram illustrating an example network environment 100 of a project tracker platform system according to one embodiment of the present invention. Here, an exemplary three-tier application design is presented with a presentation tier 110, business logic tier 120 and a database tier 130, where each tier provides a different level of responsibility and functionality to the network environment 100. Additionally, the presentation tier 110, business logic tier 120 and database tier 130 may be utilized to create a website or web portal to implement the project tracker platform system on a web based platform. Thus, the presentation tier 110 is a front end component of the project tracker platform system that is responsible for providing portable presentation logic, which may consist of standard ASP.NET web forms, active server pages, documents, and Windows Forms. Essentially, the presentation tier 110 is responsible for determining and defining what the web based platform and its interactive elements will look like to the user. This presentation tier 110 transforms the results and outputs of the business logic tier 120, as further explained below, into a form that will be usable and readable by the client and user.

The business logic tier 120 controls the project tracker platform system's functionality by performing detailed processing. In other words, the business logic tier 120 encodes real-world business rules to determine and organize how data is to be created, displayed, stored and changed. Business rules may include operations, definitions, constraints and limitations that are specifically applied to a particular organization or industry. By way of example only, an exemplary business rule implemented onto the business logic tier for the banking industry may include specific business rules specific to this industry, such as the rule that no credit checks are to be performed on return customers, or that a funds availability notice is always to be generated when a new bank location is to be opened. Such rules can then be included into the business logic tier 120 so that they are applied and executed within the project tracker platform system. As such, the business logic tier 120 is capable of sending out data requests to a database tier 130, so that specific business rules may be managed and executed. The business logic tier 120 may be physically located on the server that hosts the web service in the presentation tier 110.

The exemplary three-tier application design may also include a database tier 130. The database tier 130 includes data persistence mechanisms, such as database servers, storage and files shares, which can be shared and in communication with the presentation tier 110 and business logic tier 120. Additionally, the database tier 130 may define how the data is to be retrieved and stored in the database tier 130.

The network environment 100 may further be responsible for enforcing security measures so that only certain approved users are able to retrieve sensitive and access private data and information. Because security is a major concern in the web development area, it is especially concerning when or organization or company shares sensitive and private information over the Internet. This is particularly true with various malware and cyber attackers lurking and ready to intercept information sent and received over the Internet. As such, in some embodiments, an active directory 140 is utilized to authenticate users attempting to gain access to the project tracker platform system. The active directory 140 may determine what selected information and data will be presented to the user, as well as determining which certain web portal pages will be accessible to the user.

In other instances, the active directory 140 may only be used an initial or first authentication system to determine whether or not the user has initial access to the project tracker platform system. All further identification requests, such as those to determine a user's approved access to select portions of the project tracker platform system are sent to the server database.

Once the particular user is granted access to the web based portal of the project tracker platform system, the user's information may be synced to the business logic tier 120, so that the user's project tracker platform system profile is accessible to the user. In some instances, the user's information may be located in the database tier 130, which is located and transmitted to the business logic tier 120 accordingly, thus allowing the project tracker platform system to seamlessly provide the appropriate workflow access and data to the user.

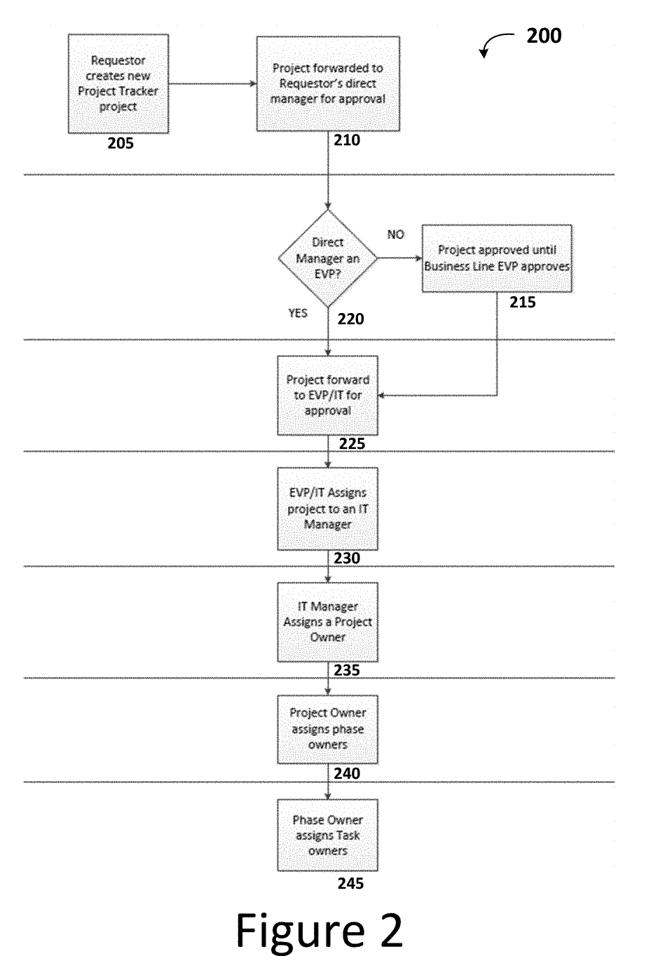

FIG. 2 is a flow diagram illustrating an example flow process 200 of creating and approving a project in a project tracker platform system according to one embodiment of the present invention. Each user on the project tracker platform system may be assigned a specific role, and depending on that role, certain rights and clearances are assigned to determine a user's access to various parts of the project tracker platform system. For example, verified users identified as full time employees or users working within select pre-approved departments, such as the information technology department or human resources department, may have the qualification to create or submit new projects for approval. Those not pre-approved with the clearance to create or request new projects may not have the option or access this feature in his or her project tracker platform. However, in some instances, a user not initially granted with clearance to submit project proposal requests may be granted temporary access to do so.

As illustrated, the process 200 includes a verified user with granted access to create a project proposal request at step 205. In the instance that the user seeks to create a project approval request, the user may log onto the project tracker platform system to fill out and submit the project approval request form. By way of example only, the dashboard or web portal page of the user's project tracker platform system may include a specific page or area dedicated to submitting new projects for approval. In such an instance, the user may click open a “New Project” web page on the user's project tracker platform system and include the necessary details of the proposed new project to be submitted for approval. In some embodiments, the “New Project” web page may contain interactive fields to help the user provide the necessary information required for approval.

Exemplary proposed projects may include opening new bank branches, creating a new software to automate the dual signature process on all cashier's checks, creating a mobile application to upload the customer's account information in real time, improved internal security initiatives, etc. Essentially, the proposed projects may include any project proposal that allows for detailed tracking of milestones and tasks, where the workflow of the project can be assigned and managed by a group of users via a web portal.

When the proposed new project is submitted, it needs to be approved by a second user pre-approved to review and approve project requests, such as those users given an administration or manager role. By way of example, the project proposal may be sent for approval to the requesting user's direct manager, as indicated at step 210. However, it should be noted that the proposed new project request may be sent to any user that is authorized to approve or deny project proposals.

In some embodiments, the proposed new project request may need to be approved by more than one user with an administration or manager role, as indicated at step 215. Here, the exemplary project proposal must be additionally approved by a higher authority figure, such as an executive vice president. However in other instances, the project proposal may need to be only approved by one user with an administration or manager role authorized to do so. Thus, by example, where the initial approval comes from an executive vice president, additional approval is not required since the initial approval is already authorized by a high ranking personnel in the organization, as indicated at step 220.

However where the project proposal needs the approval of more than one authorized personnel, the project proposal may be forwarded to other authorized personnel as indicated at step 215 and 225. Users with the clearance to approve proposed new projects may herein be collectively referred to as approval managers.

Once the project proposal has been approved by all the necessary approval managers, the approval manager may then assign the now approved project to a department manager that will most likely be in charge of overseeing the project, as indicated at step 230. The department manager may then assign the project to an employee that will be in charge of actively managing and supervising the details of the project from the start to the end, otherwise referred to herein as the project manager, as indicated at step 235. Thus, the project manager may be in charge of dividing up the work amongst a group of users and will also be in charge of monitoring the progress and status of the project.

To ensure that projects are managed and adequately tracked throughout its lifecycle, the project may be divided up into phases or milestones. By way of example, phases may include a planning phase, an execution phase, a performance and control phase, an implementation phase, a maintenance phase, and a completion phase. As such, the project manager may assign a user to be a phase owner, as indicated at step 240. The phase owner may be responsible for ensuring that the assigned tasks and assignments associated with his or her assigned phase is completed and ready for final review by the project manager. The phase owner may be more involved with the details and execution of certain aspects of the project, such as specific phases in order to ensure that the work quality is set to the standard that is expected by the organization or company. Dividing the management of the project between a project manager and a phase owner ensures that both a wide management overview and a more detailed overview of the project is maintained.

In the instance that the phase owner is responsible for overseeing that the tasks and assignments related to the assigned phase is completed, the phase owner may assign specific tasks or assignments to a select user or a group of users, as indicated at step 245. Additionally, the select user or groups of users assigned to specific tasks or assignments will herein be referred to as task owners. Thus, the task owners are responsible for ensuring that the work details associated with the project is completed. When the task owners are finished with their assigned tasks, the phase owner may be notified. The phase owner may review all completed assignments and tasks associated with his or her assigned phase. When the assigned phase is deemed completed, the phase manager may alert the project manager. The project manager may then review the completed phase and signal the start of the next phase of the project.

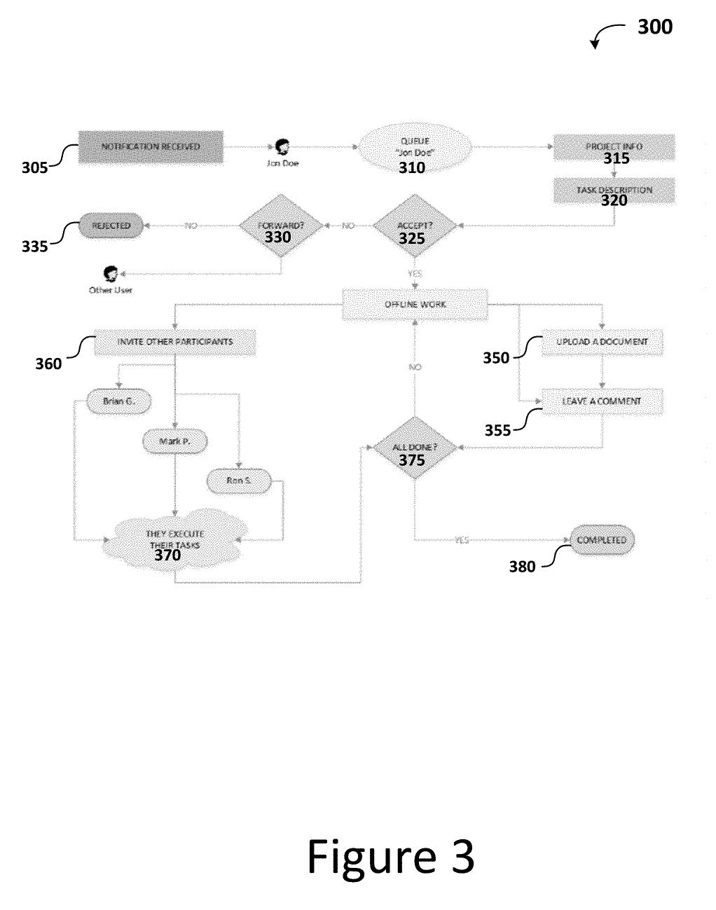

FIG. 3 is a flow diagram illustrating an example phase completion process 300 of an approved project in a project tracker platform system according to one embodiment of the present invention. As illustrated, the phase completion process 300 of a project may start at step 305, where a selected user is notified that a particular task of a project has been assigned to the user. When notified, all information with regards to the assigned task is then accessible to the user on the user's project track platform system, as indicated at step 310. The notification may come through the selected user's email and/or a communication tool panel on the user's dashboard page of the project tracker platform system, which is further described in detail below. The notification may include project information 315 and the task description 320, where the task description 320 provides the general instructions for completing the task, as well as deadline information.

In the instance the particular phase of the project requires only one task, only one user may be notified of the single task to be completed. However, in the instance that the particular phase of the project requires two or more tasks in order for the phase of the project to be completed, one or more users may be assigned and notified of the various different tasks that need to be completed.

Next, in some instances, the user may have the option of accepting the assigned task within the project tracker platform system, as indicated at steps 325. In the instance that the assigned user accepts the task, the user is then given access to certain features of the project tacker system required to complete the task, as indicated at steps 350 and 355. Such features may include uploading the necessary documents or paperwork necessary to complete the assigned task. Additionally, the user may be able to send comments to communicate with the other users working on the project. Uploading the documents and leaving comments at steps 350 and 355 may all be accessed and performed on the dashboard or web page of the user's project tracker platform system. However, in other instances, the user may not have the option of either accepting or rejecting the assigned task via the project tracker platform system and instead, must verbally communicate his or her wish to remain uninvolved in the initially assigned task.

However, in the instance that the user decides not to accept the assigned task and has the option to do so within the project tracker platform system, the user may forward or recommend the task be assigned to a different user, as indicated at step 330. When the assigned user forwards the task to a different user, the user may recommend another user, but the project manager may still need to authorize whether the recommended user is qualified to work on the assigned task. In other instances, the user may not forward the task to another user and instead, may reject the assigned task altogether, as indicated at step 335.

If the recommended users accept the task, then the recommended users will have access to parts of the project tracking system associated with the assigned task. Depending on the security clearance of the project, where the project contains highly sensitive data and information, the user's project tracking system may only show or allow access to certain information and data that is specifically related to the user's assigned task. However, in the instance that the project does not contain highly sensitive data or confidential information, the project tracking system may provide the users with a wider range of access documents and information with regards to the project.

Each of the users participating in the completion of the task may be required to indicate the status of their assigned tasks so that the project, phase and/or task owner is able to assess the status of the phase or overall project at all times. However, at some point, the project manager or phase owner may realize that additional tasks or help from additional users are required in order for the particular phase of the project to be completed. If so, users already working on a task or a phase owner may invite other participants to join and help complete the particular phase of the project, as indicated at step 360. Again, invited participants may receive a notification and may have the option of accepting or rejecting the invitation to complete the assigned task. In this particular example, three additional users are invited to accept a task to help complete the phase of the project. By way of example only, a particular project may have 5 separate phases, such as unit and integration testing phase, quality assurance phase, procedure/training phase, penetration test phase, and security testing phase.

When each of the users assigned to the selected tasks have been completed, that particular phase of the project is deemed to be completed, as indicated at steps 370, 375 and 680. If so, the project manager may be alerted of the completion of the phase, which may then be indicated on the dashboard of the project manager's page.

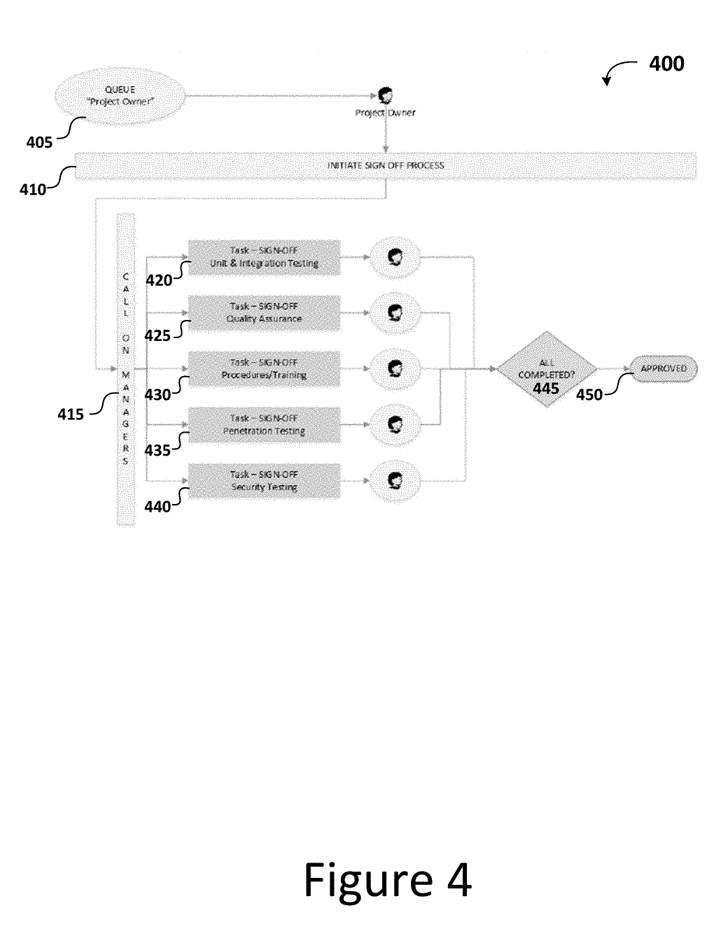

FIG. 4 is a flow diagram illustrating an example sign off process of a completed project in a project tracker platform system according to one embodiment of the present invention. Here, the assigned project manager is notified when a project he or she is managing has been completed. The project may be queued in the list of completed projects that needs to be reviewed and approved in the dashboard page of the project manager's project tracking system, as indicated at step 405. Next, at step 410, the project manager may initiate the sign off process of the project.

Thus, at step 415, the project manager may alert each of the assigned phase owners that his or her assigned phase is currently being reviewed in order to initiate the sign off process of the project. Here, the project manager may have complete access to the entire project folder and is able to review each of the completed tasks of every phase of the project to determine whether or not to sign off on the phase. Additionally, if a particular phase is not ready to be signed off and approved, the project manager may message the phase owner, as well as the task owner, and notify them of any particular issues or problems with the one or more tasks in that particular phase. However in other instances, the project manager may not be assigned with the responsibility of reviewing and signing off on each of the phases. Rather, once each of the task have been reviewed and signed off by the corresponding task owners, the project phase is then deemed automatically signed off. The project manager just then confirms the status and then acknowledges that the phase has been signed off.

In other instances, the project manager may assign a status label on the unapproved task indicating that the task has been unapproved and needs revisions before it is approved and signed off. The phase owner and the task owner may then be alerted and required to revise the task for resubmission for an additional round of review by the project manager before the phase is officially signed off.

When all of the phases of the project have been approved by the project manager, each of the phases are deemed to be signed off, as indicated at steps 420, 425, 430, 435 and 440. Once all the phases have been signed off, the project is then deemed to be completed and approved, as indicated at steps 445 and 450.

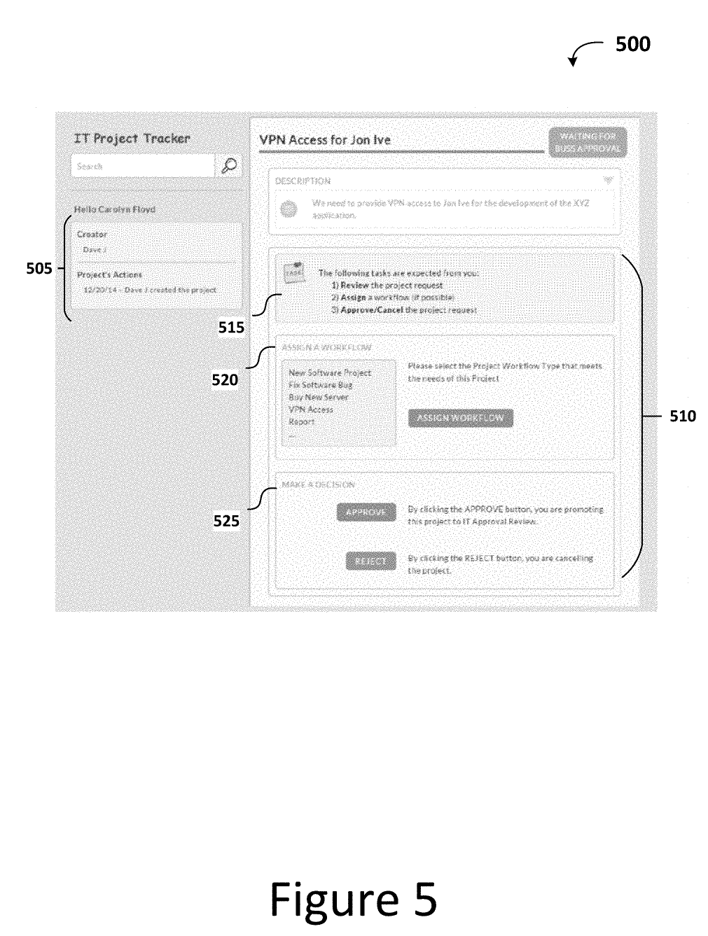

FIG. 5 is an illustration of an exemplary project approval page 500 of a project tracker platform system according to one embodiment of the present invention. As discussed above with respect to FIG. 2, new project approval requests may only be viewed and approved by approval managers. As such, the exemplary project approval page 500 may only be accessible to approval managers. As depicted, the exemplary project approval page 500 allows an approval manager to determine whether or not to approve the received project proposal.

Here, the project approval page 500 may include a proposed project information panel 505 and a project approval panel 510. The project information panel 505 may include basic information associated with the project approval request, such as the user who requested the project approval request and all logged activity associated with the project approval request thus far. Here, the project information panel 505 shows that Dave J. created the project approval request, as well as the logged date the project approval request was created.

The project approval page 500 may also include a project approval panel 510, which may be an interactive panel that allows the approval manger to approve the proposed new project request. Within the project approval panel 510, a task panel 515 may be present. The task panel 315 may list the tasks that are expected to be completed by the approval manager. Here, the approval manager is expected to 1) review the project request; 2) assign a workflow to the proposed project if possible; and 3) approve or cancel the project request. To complete these tasks, the project approval panel 510 may provide interactive panels that allow the project manager to complete these tasks, such as a workflow panel 520 and a decision panel 525.

The workflow panel 520 may allow the approval manager to assign a workflow template to the proposed project. Different project types are assigned different workflow templates. The workflow templates provide as a starting point or shell for each project type. Once the project is approved and the project manager is assigned, the selected workflow template may be modified and updated by the project manager and phase owner. Because the workflows of each project may be divided into distinct steps, such as phases, the workflow templates may be configured to include these phases.

The project approval page 500 may also include a decision panel 525. The decision panel 525 may allow the approval manager to approve or reject the proposed new project request. In the instance that the approval manager approves the proposed new project request, the project tracker platform system may implement the selected workflow template so that users may start working on the project. Additionally, the project tracker platform system may then allow select users to be assigned to the project, such as the project manager, phase owner, and task owner. However, in the instance that the approval manager does not approve the proposed new project request, the project is cancelled. Additionally, the requestor or user who submitted the proposed new project request may be notified of the rejected project proposal.

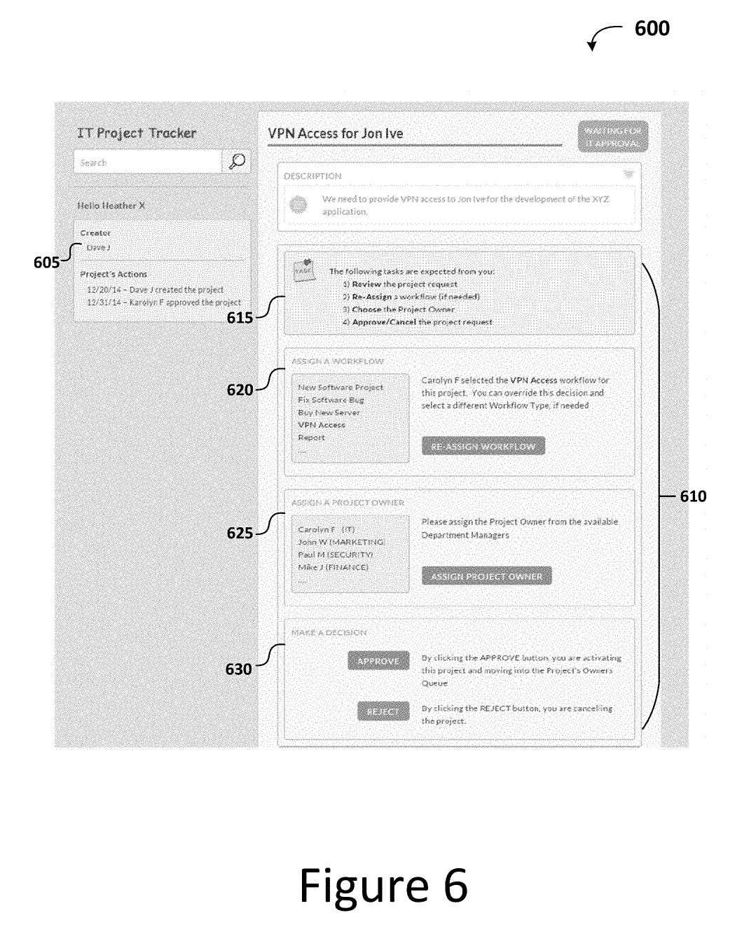

FIG. 6 is an illustration of an exemplary second project approval page 600 of a project tracker platform system according to one embodiment of the present invention. Once the first approval manager accepts the proposed new project request, as illustrated and described in detail with respect to FIG. 5, a second project approval page 600 may be presented to the second approval manager. Again, the second project approval page 600 may only be accessible to approval managers with clearance to view and approve project requests.

Here, as illustrated in FIG. 6, the second project approval page 600 includes a proposed project information panel 605 and a project approval panel 610. The project information panel 605 may include basic information associated with the project approval request, such as the creator of the project proposal and all actions associated with the project proposal thus far. Here, the project information panel 605 shows that Dave J. created the project proposal as well as the date Dave J. created it. Additionally, the project information panel 605 also shows the name of the first approval manager who approved the project approval request and the date it was approved.

The project approval page 600 may also include a project approval panel 610, which may be an interactive panel that allows the second approval manger to approve the project proposal already initially approved by a first approval manager. In this example, only when the second approval manager confirms the approval of the project request will the project be activated and approved.

Within the project approval panel 610, a task panel 615 may be present. The task panel 415 may list the tasks that are expected to be completed by the second approval manager. Here, the approval manager is expected to 1) review the project request; 2) re-assign a workflow to the proposed project if needed; 3) choose the project manager; and 4) approve or cancel the project request. To complete these tasks, the project approval panel 610 may provide other interactive panels that allow the project manager to complete these tasks. The interactive panel may include a workflow panel 620, project manager panel 625 and a decision panel 630.

The workflow panel 620 may allow the second approval manager to override the initial workflow template selected by the prior approval manager. In the instance that the second approval manager decides that a different workflow should be assigned to the project, the second approval manager may do so by re-assigning a different workflow template. When a different workflow template is selected, the first approval manager may be notified of the workflow template change, and the first approval manager may need to approve the change before the re-assigned workflow selection is implemented. In other instances, approval from the first approval manager is not required.

The project manager panel 625 may allow the second approval manager to assign a project manager to the proposed project. By way of example, one or more project managers may be assigned to each project. When selecting the “Assign Project manager” button on the project manager panel 625, a list of pre-approved users qualified to supervise the project as a project manager may be generated.

The project approval page 600 may also include a decision panel 630, where the second approval manager may approve or reject the project. By approving the project, the second approval manager is activating the project, which allows authorized users to start working the project. When approved, the project is then placed in the assigned project manager's dashboard of the project tracker platform system. Thus, the selected project manager is now able to access the assigned workflow template as well as obtain access to the project detail and information from the project tracker platform system to supervise and manage the assigned project from start to finish.

However, in the instance that the approval manager does not approve the project proposal, the project is cancelled. The first approval manger may be notified that the project proposal was rejected. Additionally, the requestor or user who submitted the proposed new project request may also be notified.

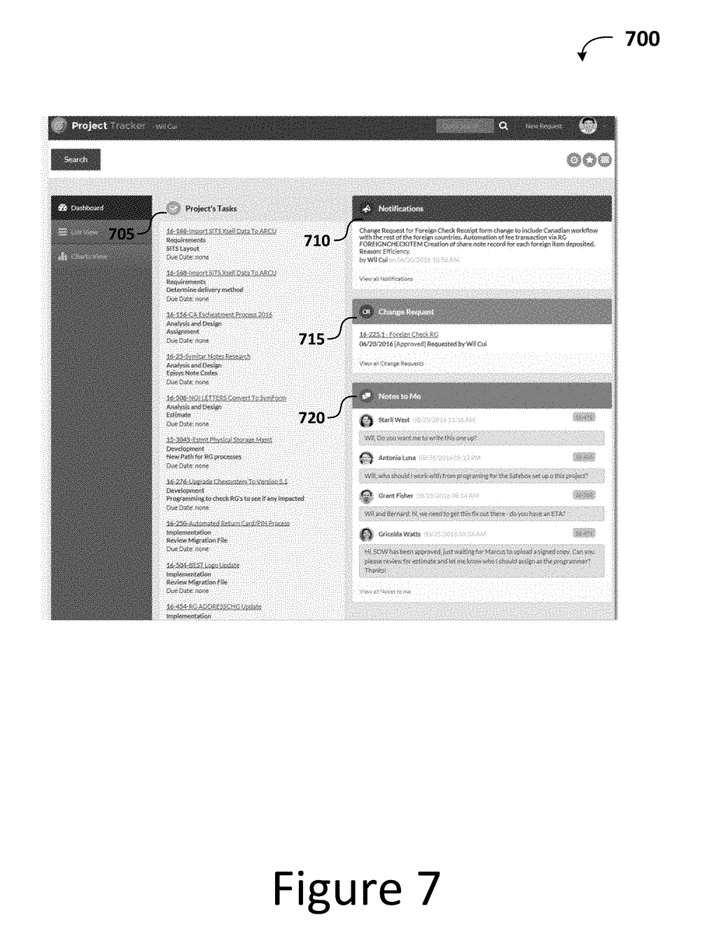

FIG. 7 is an illustration of an example dashboard page 700 of a project tracker platform system according to one embodiment of the present invention. The dashboard page 700 may be the main landing page when the user logs onto the project tracker platform system. Thus, the dashboard page 700 may contain most of the authorized rights and information that is accessible to the user based on the user's assigned role and security clearance level within his or her company or organization. The main dashboard page 700 allows the user to contribute to his or her assigned responsibilities for the project within the project tracker platform system.

Here, the exemplary dashboard page 700 may be the landing page of a phase owner or a task owner. As such, this particular landing page may only be accessible and contain certain rights that are only available to phase owners or task owners. As illustrated, this particular dashboard page 700 includes a project task list 705. Here, the project task list 705 may indicate all of one or more projects and the associated tasks. Thus, if this dashboard page 700 was configured to be used by a phase owner, the project task list 705 may show all the tasks that are required to be completed in the particular phases of the project that are assigned to the phase owner. Thus, the phase owner is able to monitor and track all of the tasks that have been assigned to certain task owners within the phase owner's dashboard page 700.

However, in the instance that the dashboard page 700 is configured for a task owner, the project task list 705 may show all the tasks that have been assigned to the task owner. Thus, these are the tasks the task owner is responsible for completing. Thus, all of the tasks are located in one designated area in the task owner's dashboard page 700, which allows the task owner to quickly and easily determine what tasks need to be completed.

Additionally, the dashboard page 700 may also include a notification panel 710. This notification panel 710 may be included in the dashboard page 700 of every user, regardless of his or her assigned role. This notification panel 710 may provide alerts to the user that are triggered when a task has been completed. In other instances, the notification panel 710 may allow other users to provide alerts to one another to indicate that a certain particular matter requires the user's attention.

The dashboard page may also include a request panel 715. The request panel may be included in the dashboard page 700 of those users that are given the access to approve certain requests. While the approval of a project request is limited to project managers, as discussed above in detail, other types of requests may be necessary during the lifecycle of the project. For example, a request to change certain documents or request to change the due date of a task or assignment may be required. Thus, the request panel 715 allow users to send requests to another user that has the authority to reject or approve such requests. Thus, this allows the user to quickly determine if a particular request requires his or her approval and is able to quickly do so with the use of the request panel 715.

In some instances, a note panel 720 may also be included in the dashboard page 700. The note panel 735 may be located on the dashboard page of any user using the project tracker platform system regardless of his or her assigned role. By way of example, the note panel 735 may be used as a communication tool to provide a way for a group of users to communicate with one another. In some instances, users may only be able to communicate with other users working on the same project. In other instances, the users may be able to communicate with any user authorized to log into the project tracker platform system, which thus may be used as an office communication tool. More detail with regards to the note panel 735 is discussed in greater detail below.

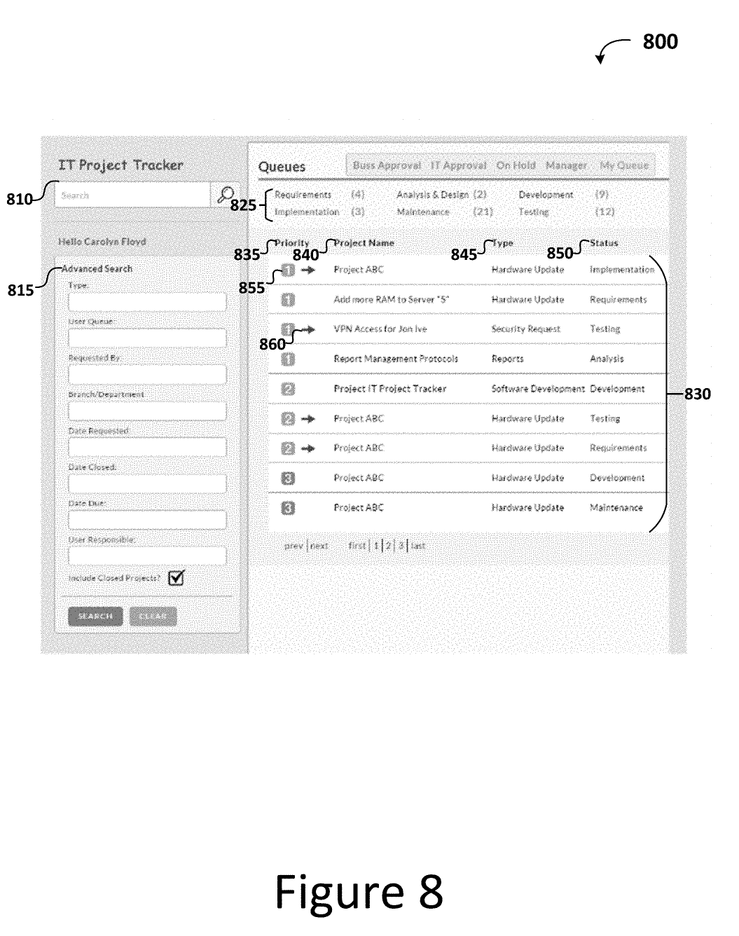

FIG. 8 is a diagram illustrating an example project queue page 800 of a project tracker platform system according to one embodiment of the present invention. As illustrated, the project queue page 800 displays all the internal projects assigned to the particular project manager so that he or she may easily monitor and track the workflow of all the assigned projects all in one web portal page.

The dashboard page 800 may be divided into two main areas. The left side with general search capabilities and the right side with a display area to present specific project data and information. Specifically, the left side may include a search field 810, where the user may input the project name to find the project information. Additionally, an advanced search field 815 may be included. The advanced search field 815 may allow an authorized user, such as the project manager, to search for a particular project by inputting specific project information. Such project information may include project type, user queue, requested by, branch/departments, date requested, date closed, date due, and user responsible.

The resulting searches may list only projects that are assigned to the project manager. Particular projects that are not assigned to the project manager may not be visible on the project manager's dashboard page 800. This allows for a secure solution in managing various projects within a company or organization with sensitive and restricted information, especially when such information cannot be shared with all users in the project tracker platform system.

Additionally, on the right side of the dashboard page 800, the dashboard page 800 may present specific project data and information, which may be divided into two sub areas: queue project status summary 825 and queue project list 830. The queue project status summary 825 displays the status or the select phase of the projects, as well as the number of projects that are currently in that status or phase. This quickly allows the project manager to determine how many of his or her projects are in the beginning, middle or end stages of the project.

Below the queue project status summary 825 is the queue project list 830. The queue project list 830 may provide a detailed summary of each project that is assigned to the project manager. For example, the queue project list 830 may provide the project name 840, project type 845 ,and detailed status information 850. Additionally, the priority information 855 may also be included, which may be categorized by a numerical ranking system to indicate the whether the project is time sensitive or not. Here, a number 1 indicates that the priority of the project is urgent and a number 3 indicates non-urgent deadline. Other ranking systems as appreciated by a person of ordinary skill in the art may be used and is not limited to a numerical ranking system.

Additionally, the queue project list 830 may also include other information to help the user monitor and track the various projects on his or her docket. By way of example only, notification markers 860 may be presented next to the name of a project to alert the project manager that an action that needs to be reviewed by the project manager. For instance, when a particular phase of the project is finished and requires the project manager to review and sign off on the completion of the particular phase, the project name in the dashboard page 800 may be highlighted with the notification marker 860. This allows the project manager to actively monitor and track various projects in real time to ensure that projects are completed in a timely manner.

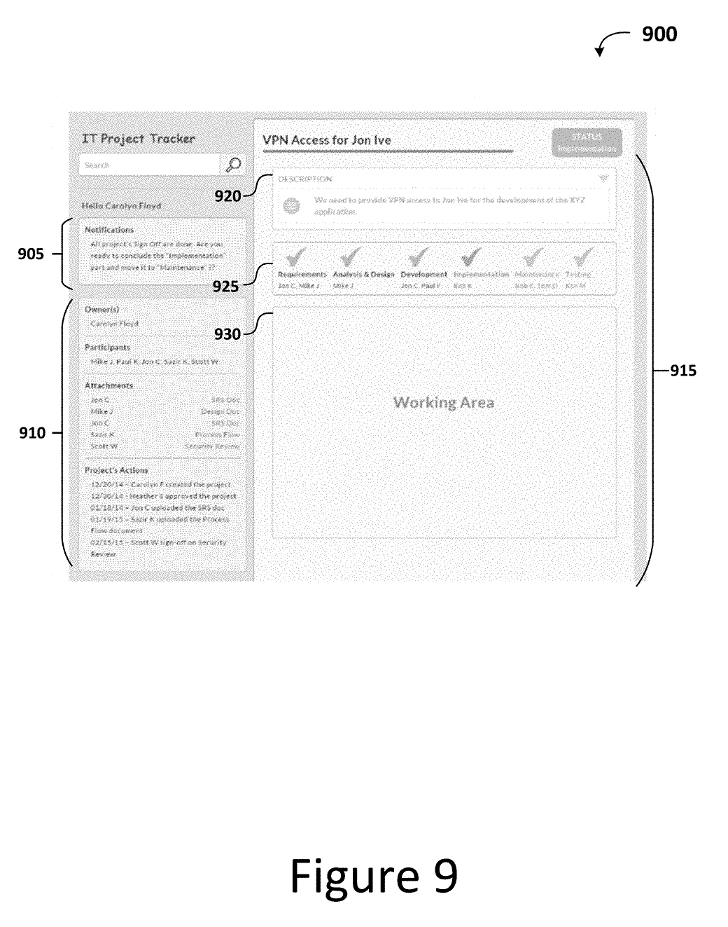

FIG. 9 is a diagram illustrating an example project information page 900 of a project tracker platform system according to one embodiment of the present invention. As illustrated, the project information page 900 may provide more detailed information about the particular project when selecting on the project name on the user's dashboard page or queue page, as illustrated at discussed in detail with respect to FIGS. 7 and 8. Thus depending on the type of user and his or her access to certain information and web pages of the project tracker platform system, the project information page 900 is tailored to display information that is granted to the user.

Here, the project information page 900 may be divided up into two panels, an information panel that consists of a notification sub-panel 905 and overview sub-panel 910, and a working panel 915. The notification sub-panel 905 may include any alerts and notifications with respect to the selected project at hand. The notification may be automatically generated by the project tracker platform system with the completion of a task or based on the status of the project. In other instances, other users may message the project manager via a chat communication tool within the project tracker platform system, in which the message is displayed in the notification sub-panel 905.

Additionally, the notification sub-panel 910 may provide general project information, such as the project manager or the user with access to the project information page 900. Additionally, the names of the participants invited to work on the project may be displayed. These participants are thus users that have been invited to complete specific tasks needed to complete the project. Other information included in the overview sub-panel 910 may include document upload attachment information and project actions. The document upload attachment information may provide a list of all document files uploaded onto the project tracker platform system for this particular project. Additionally, information such the participant who uploaded the document may also be logged and recorded, as well as provide access to the link of the document. Based on the user's clearance, access to open the document file may be limited. However, if the user is a project manager, the project manager may have default access to most, if not all areas, of the project tracker platform system related to his or her assigned projects.

The project action information listed in the overview sub-panel 910 may also list key timeline events and provide a brief description of those events, such as the date and the participant information. This may allow the user, such as the project manager, phase owner or task owner to quickly glance and determine all actions that have been taken with respect to this particular project.

The project information page 900 may also include a working panel 915. The working panel may include a description area 920, status indicator 925 and a working area 930. The description area 920 may provide a quick description of the project. The status indicator 925 may indicate the current status of the project by showing which phases of the project have already been completed and the phases that still need to be accomplished. Here, three phases of the project have already been completed, such as the requirements phase, analysis and design phase, and development phase. The implementation phase is currently in the process of being completed, while the maintenance phase and testing phase still need to be completed before the project is completed and ready for the project manager's sign off.

The working area 930 may display specific data, information or actions that allow the user to complete the assigned task or the project at hand depending on the current workflow process status. In the instance that this project information page 900 is to be viewed by the project manager, the working area 930 may allow the project manager to click on the completed tasks as indicated in the status indicator 925 and review all the completed tasks. Where the competed task includes one or more documents, the project manager may be able to open those documents in the work area 930. In some instances, the project manager may even have the ability to implement changes onto the document and/or provide comments and feedback within the document. But if this project information page is to be used by a task owner, the task owner has much more limited access than the project manager. As such, the task owner may not have the clearance to open documents from other aspects of the project that have not been assigned to the task owner. As such, the task owner may be limited to opening documents and folders that are related specifically to his or her assigned task and may not be able to view the work or progress of other phases that have not been assigned to the user. Thus, the working area 930 may be tailored to the user's allowed access within the project tracker platform system.

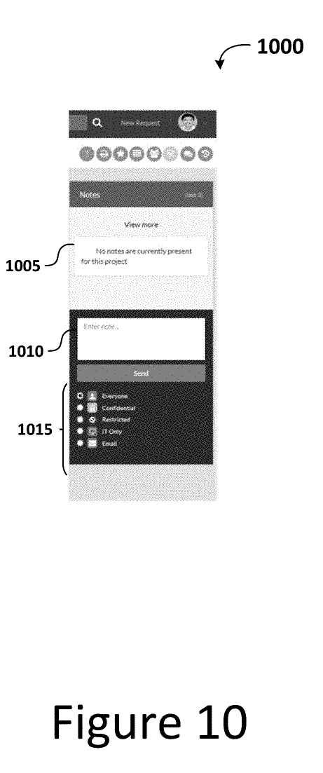

FIG. 10 illustrates an example note panel 1000 on a dashboard of a project tracker platform system according to one embodiment of the present invention. This note panel 1000 may be included on the dashboard page of any user using the project tracker platform system. The note panel 1000 is a communication tool that allows the user to input messages or reminders. The user may input the message or reminder in the field 1010, in which the message is saved and displayed in the viewing area 1005. The user may select how the message is to be shared at 1015. For instance, the user may wish to use the note panel 1000 to send a reminder to another user about a task deadline approaching. In that instance, the user may have the option of sending the message or reminder to every user or selected users. In other instances, the user may wish to send a note or message via email instead of having the message delivered via the note panel 1000. When the message or reminder is submitted to the selected users, the log of the message or reminder may be viewable in the viewing area 1005. Additionally, the user may have the option of keeping the note confidential so that the note is a personal reminder that is to be viewed by the user only.

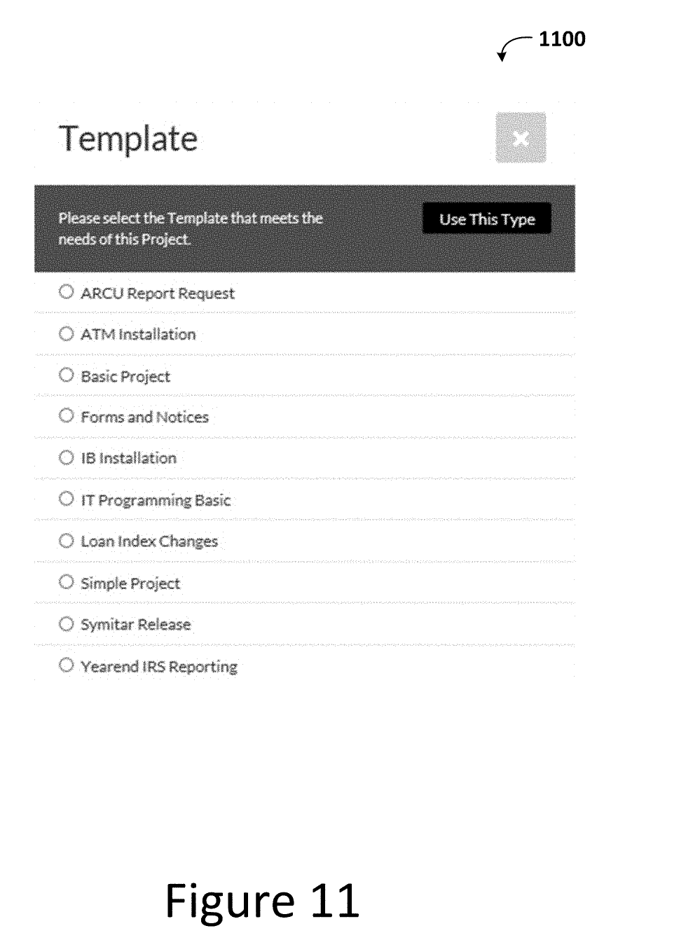

FIG. 11 illustrates an example template panel 1100 according to one embodiment of the present invention. A template panel 1100 may be included in the project approval page of a user, such as the one as described and illustrated with respect to FIG. 5 or FIG. 6, where the template was referred to as the workflow template. The template panel 1000 may a may be included where the project manager, or any authorized user, wishes to select a template for a particular project.

Exemplary project templates may be implemented based on the project type, such as ACRU report request, ATM installation, basic project, forms and notices, IB installation, IT programming basic, loan index change, simple project, symitar release, and yearned IRS reporting. Should the project type be listed in the template panel 1000, the project manager may select the template to be used. By way of example only, the template may automatically upload and generate the necessary documents or steps needed to complete the task. The template may also provide the necessary list of tasks to be completed, such that the provided template provides a basic shell or starting point for completing the project. The template may be modified at any point by a user with access to do so, such as a project manager or a phase owner

Where the template panel 1000 does not provide the necessary template for the project at issue, an authorized user, such as a project manager, may create his or her own template. The new created template may then be saved onto the template panel 1000 so that it can be used later again for other projects.

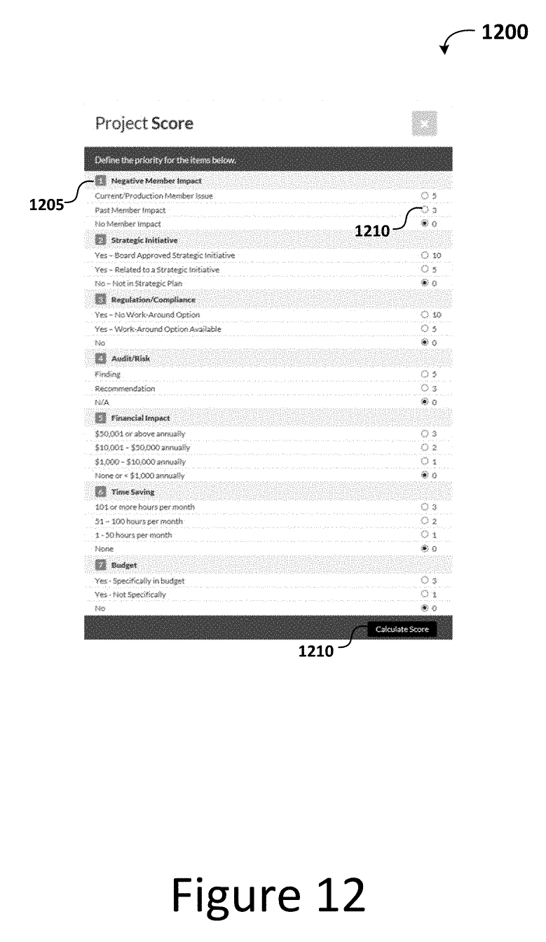

FIG. 12 illustrates an example project score calculator panel 1200 of a project tracker platform system according to one embodiment of the present invention. The project score calculator panel 1200 may be displayed on the project approval page of a user, such as the one as described and illustrated with respect to FIG. 5 or FIG. 6. The project score calculator panel 1200 may provide a score that is assigned to each project, which provides a calculated score to assess whether or not the project is time sensitive in nature.

To determine the calculated score, the authorized manager may need to provide some information 1205 to help determine whether or not the project is time-sensitive. Such information 1205 that may be provided may include impact for failure to complete task, whether there is a strategic initiative in place, a work around option, required audit requirement, financial impact, time saving option, and a budget determination. These are exemplary information requests and other information may be requested, depending on the industry and type of project.

The answers or information selected on the project score panel may be correlated to a numerical value. By way of example, the numerical value may indicate the level of urgency, where a lower numerical value indicates lack of urgency with respect to a time deadline and a higher numerical value indicates a higher level of urgency. Once all the information is provided or selected, the user may press the “calculate score” button 1210. The numerical values associated with the information provided may be averaged to determine the score.

The generated score may help indicate to the authorized managers and the users working on the project the time sensitive nature of the project. In the instance that the project is urgent and/or contains a specific deadline, the calculated score will consider this into account. Thus, based on the determined project score, necessary alerts and notifications along the course of the project timeline may be implemented to remind the users of any looming deadlines or of the time sensitive nature of the project.

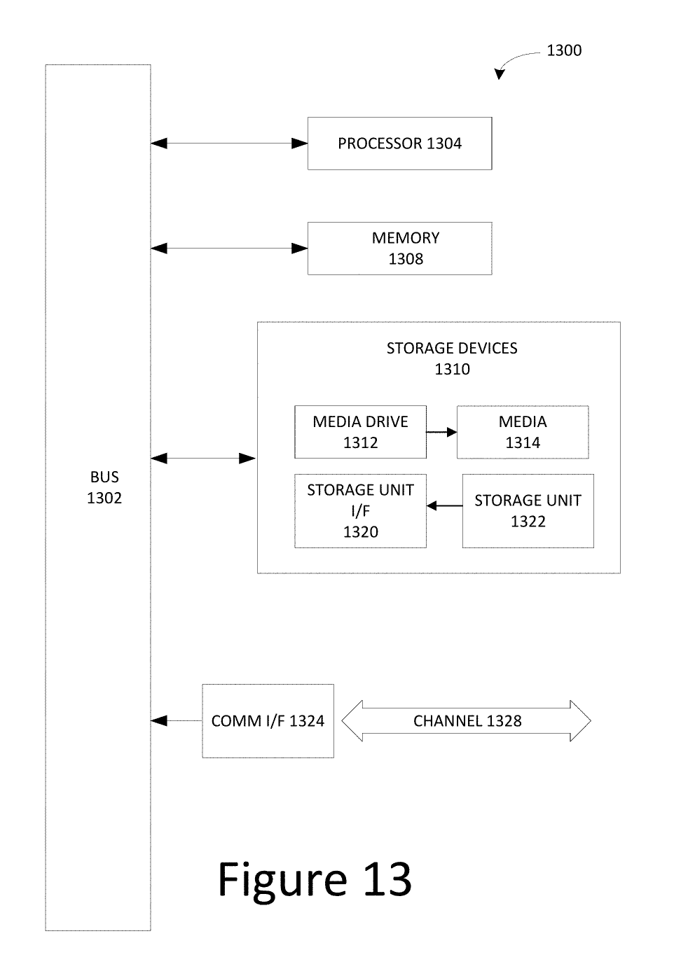

FIG. 13 illustrates example computing module 1300, which may in some instances include a processor/controller resident on a computer system. Computing module 1300 may be used to implement various features and/or functionality of embodiments of the systems and methods disclosed herein. As used herein, the term module may describe a given unit of functionality that may be performed in accordance with one or more embodiments of the present application. As used herein, a module may be implemented utilizing any form of hardware, software, or a combination thereof. For example, one or more processors, controllers, ASICs, PLAs, PALs, CPLDs, FPGAs, logical components, software routines or other mechanisms may be implemented to make up a module. In implementation, the various modules described herein may be implemented as discrete modules or the functions and features described may be shared in part or in total among one or more modules. In other words, as would be apparent to one of ordinary skill in the art after reading this description, the various features and functionality described herein may be implemented in any given application and may be implemented in one or more separate or shared modules in various combinations and permutations. Even though various features or elements of functionality may be individually described or claimed as separate modules, one of ordinary skill in the art will understand that these features and functionality may be shared among one or more common software and hardware elements, and such description shall not require or imply that separate hardware or software components are used to implement such features or functionality.

Where components or modules of the application are implemented in whole or in part using software, in one embodiment, these software elements may be implemented to operate with a computing or processing module capable of carrying out the functionality described with respect thereto. One such example computing module is shown in FIG. 13. Various embodiments are described in terms of example computing module 1300. After reading this description, it will become apparent to a person skilled in the relevant art how to implement the application using other computing modules or architectures.

Referring now to FIG. 13, computing module 1300 may represent, for example, computing or processing capabilities found within mainframes, supercomputers, workstations or servers; desktop, laptop, notebook, or tablet computers; hand-held computing devices (tablets, PDA's, smartphones, cell phones, palmtops, etc.); or the like, depending on the application and/or environment for which computing module 1300 is specifically purposed.

Computing module 1300 may include, for example, one or more processors, controllers, control modules, or other processing devices, such as a processor 1304. Processor 1304 may be implemented using a special-purpose processing engine such as, for example, a microprocessor, controller, or other control logic. In the illustrated example, processor 1304 is connected to bus 1302, although any communication medium may be used to facilitate interaction with other components of computing module 1300 or to communicate externally.

Computing module 1300 may also include one or more memory modules, simply referred to herein as main memory 1308. For example, random access memory (RAM) or other dynamic memory may be used for storing information and instructions to be executed by processor 1304. Main memory 1308 may also be used for storing temporary variables or other intermediate information during execution of instructions to be executed by processor 1304. Computing module 1300 may likewise include a read only memory (ROM) or other static storage device coupled to bus 1302 for storing static information and instructions for processor 1304.

Computing module 1300 may also include one or more various forms of information storage devices 1310, which may include, for example, media drive 1312 and storage unit interface 1320. Media drive 1312 may include a drive or other mechanism to support fixed or removable storage media 1314. For example, a hard disk drive, a floppy disk drive, a magnetic tape drive, an optical disk drive, a CD or DVD drive (R or RW), or other removable or fixed media drive may be provided. Accordingly, removable storage media 1314 may include, for example, a hard disk, a floppy disk, magnetic tape, cartridge, optical disk, a CD or DVD, or other fixed or removable medium that is read by, written to or accessed by media drive 1312. As these examples illustrate, removable storage media 1314 may include a computer usable storage medium having stored therein computer software or data.

In alternative embodiments, information storage devices 1310 may include other similar instrumentalities for allowing computer programs or other instructions or data to be loaded into computing module 1300. Such instrumentalities may include, for example, fixed or removable storage unit 1322 and storage unit interface 1320. Examples of such removable storage units 1322 and storage unit interfaces 1320 may include a program cartridge and cartridge interface, a removable memory (for example, a flash memory or other removable memory module) and memory slot, a PCMCIA slot and card, and other fixed or removable storage units 1322 and storage unit interfaces 1320 that allow software and data to be transferred from removable storage unit 1322 to computing module 1300.

Computing module 1300 may also include a communications interface 1324. Communications interface 1324 may be used to allow software and data to be transferred between computing module 1300 and external devices. Examples of communications interface 1324 include a modem or softmodem, a network interface (such as an Ethernet, network interface card, WiMedia, IEEE 802.XX or other interface), a communications port (such as for example, a USB port, IR port, RS232 port Bluetooth° interface, or other port), or other communications interface. Software and data transferred via communications interface 1324 may typically be carried on signals, which may be electronic, electromagnetic (which includes optical) or other signals capable of being exchanged by a given communications interface 1324. These signals may be provided to communications interface 1324 via channel 1328. Channel 1328 may carry signals and may be implemented using a wired or wireless communication medium. Some non-limiting examples of channel 1328 include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 1308, storage unit interface 1320, removable storage media 1314, and channel 1328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing module 1300 or a processor to perform features or functions of the present application as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for tracking and managing projects, comprising:
a processor;
a memory attached to the processor;
a computer readable medium having instructions embedded therein, the instructions configured to cause the processor to perform the operations of:
receiving a project request from an authorized user for a project to be created and tracked by the system;
generating a workflow template to be applied to the project when a first approval manger approves the project request;
assigning a project manager to the project; and
generating a web based platform to allow the project manager to supervise and manage a workflow of the project in real-time.

2. The system of claim 1, wherein the workflow template is applied to the project when a second approval manager also approves the new project request.

3. The system of claim 1, wherein the operations further include assigning a role to each user approved to log onto the system.

4. The system of claim 1, wherein the role assigned to each user determines a user's right to access information and select web pages from the system.

5. The system of claim 4, wherein the role assigned to each user is determined by an internal hierarchy structure of a company or an organization.

6. The system of claim 4, wherein the web based platform is tailored to provide default access of all available rights in the system to the project manager with respect to the project assigned to the project manager.

7. The system of claim 4, wherein the web based platform comprises a list of all projects that are assigned to the project manager, which includes status and project information to allow the project manager to monitor and track all assigned projects in real time.

8. The system of claim 1, wherein the project is divided into phases, each phase associated with one or more tasks to be completed.

9. The system of claim 8, wherein the project manager assigns a phase owner to one or more phases of the project, where the phase owner is responsible for supervising the tasks till the phase is completed.

10. The system of claim 9, wherein the phase owner assigns a task owner to one or more users, where the task owner is responsible for completing a task assigned to the task owner.

11. A method for tracking and managing work projects on a project tracker platform system, the method comprising the steps of:
assigning a role to each user approved to log into the project tracker platform system, such that the role assigned to each user determines a user's clearance and accessibility to information and select web pages;
receiving a request from an authorized user to create a project request for approval;
generating a project workflow template based on a project type when a first approval manager approves the project request; and
assigning a project manager to supervise a workflow of the project in real-time.

12. The method of claim 11, wherein the workflow template is applied to a project when a second approval manager also approves the project request.

13. The method of claim 12, wherein the project manager is assigned to the project by a department manager.

14. The method of claim 11, wherein the project tracker platform system is facilitated through a web-based platform.

15. The method of claim 14, wherein the role assigned to each user is determined by an internal hierarchy structure of a company or an organization.

16. The method of claim 11, wherein the project manager is granted default access of all available rights in the project tracker platform system affiliated with the project assigned to the project manager.

17. The method of claim 11, wherein the role assigns a pre-determined set of responsibilities to be performed by the user.

18. A web-based platform system comprising a non-transitory computer readable medium having a computer executable program code embodied thereon, the computer executable program code configured to:
assign a role to each user approved to log onto the web-based platform system, such that the role determines a set of responsibilities and rights provided to each user;
receive a project request from an authorized user to create a project to be tracked and monitored;
generate a workflow template to be applied to the project when an approval manger approves the project request, wherein the workflow template provides a starting point or shell for each project; and
assign a project manager to each project, the project manager responsible for tracking and supervising a workflow of the project in real-time.

19. The system of claim 18, wherein the web-based platform system grants access to selective rights and web pages depending on the role assigned to the user.

20. The system of claim 18, wherein the role assigned to the user is determined by an internal hierarchy structure of a company or an organization.
